(19) United States
(12) Patent Application Publication
(10) Pub. No.: US 2010/0013847 A1
(43) Pub. Date: Jan. 21, 2010

(54) APPARATUS AND METHOD FOR CONTROLLING LUMINANCE OF DISPLAY DEVICE

(75) Inventor: Jun-Ho Shin, Gumi-City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/438,857

(22) PCT Filed: Sep. 6, 2007
(86) PCT No.: PCT/KR07/04320

§ 371 Date: Mar. 16, 2009

(30) Foreign Application Priority Data
Sep. 8, 2006 (KR) 10-2006-0086592

(51) Int. Cl. G09G 5/02; G09G 5/10

(52) U.S. Cl. 345/589; 345/691

(57) ABSTRACT

Provided an apparatus and method for controlling luminance of a display device. The apparatus includes an analog digital converter (ADC), a video processor, a control unit, and a display unit. The ADC converts input image data into a digital signal. The video processor converts the digital signal output from the ADC into a format suitable for a display module. The control unit receives the formatted signal from the video processor and converts a luminance level of the formatted signal into modified luminance levels so as to reduce differences between output luminance levels across pixel regions of the display module. The display unit displays the input image data using the formatted signal according to the modified luminance levels.

### TECHNICAL FIELD

Embodiments relate to an apparatus and method for controlling luminance of a display device.

### BACKGROUND ART

LCD (liquid crystal display) devices are used for various devices such as a television and a mobile device for displaying images using electric and optical properties of liquid crystal molecules.

Recently, more image display devices having a large size as well as small-sized mobile devices are manufactured using LCD devices.

However, even when data of an image having a uniform luminance are input to a large-sized LCD device, the luminance of the image can be varied according to pixels of the large-sized LCD device.

FIG. 1 is a view for illustrating the luminance characteristics of an LCD device.

When a current and image data are input from an inverter 10 to an LCD module 20, the LCD module 20 displays an image using light emitted from a lamp according to the luminance information of the image included in the image data.

For example, if the LCD module 20 has a 1280*1024 resolution, the luminance of each pixel of the LCD module 20 varies in the range of 0 to 255 luminance levels according to the luminance of an image.

However, even when the LCD module 20 displays an image having a uniform luminance level, the luminance levels of the pixels of the LCD module 20 can be different according a path of a current supplied through the inverter 10, and characteristics of the lamp and the LCD module 20.

That is, even when data of an image having the same luminance level are input to the LCD module 20, the luminance of a first region 21 of the LCD module 20 can be different from that of a second region 22 of the LCD module 20.

For example, when image data having a luminance level corresponding to a luminance level of 250 of the LCD module 20 is input to the LCD module 20, the luminance level of the first region 21 can be 250, and the luminance level of the second region 22 can be 230.

Owing to these incorrect luminance characteristics of the LCD module 20, the luminance level of the LCD module 20 can be different to the luminance level of an image by one and half times. These incorrect luminance characteristics of the LCD module 20 result in user complaints.

### DISCLOSURE OF INVENTION

### Technical Problem

Embodiments provide an apparatus and method for controlling luminance of a display device so that variations of an output luminance level of the display device can correspond to variations of a luminance level of an input image when the display displays the image.

Embodiments also provide an apparatus and method for controlling luminance of a display device so that the display device can display an image at a uniform luminance level regardless of characteristics of a liquid crystal display (LCD) module and a lamp when an input image having a uniform luminance level is input to the display device.

Technical Solution

In one embodiment, there is provided an apparatus for controlling luminance of a display device, the apparatus including: an analog digital converter (ADC) converting input image data into a digital signal; a video processor converting the digital signal output from the analog digital converter into a format suitable for a display module; a control unit receiving the formatted signal from the video processor and converting a luminance level of the formatted signal into modified luminance levels so as to reduce differences between output luminance levels across pixel regions of the display module; and a display unit displaying the input image data using the formatted signal according to the modified luminance levels.

In another embodiment, there is provided a method for controlling luminance of a display device, the method including: converting input image data into a digital signal; converting the digital signal into a format suitable for a display module; converting a luminance level of the input image data into modified luminance levels using the formatted signal so as to reduce differences between output luminance levels across pixels of the display module; and displaying the input image data using the formatted signal according to the modified luminance levels.

The details of one or more embodiments are set forth in the accompanying drawings and the description below. Other features will be apparent from the description and drawings, and from the claims.

Advantageous Effects

According to the apparatus and method of the present invention for controlling luminance of a display device, input image data can be displayed without distortion of the luminance of the input image caused by the characteristics of the display device.

### BRIEF DESCRIPTION OF THE DRAWINGS

FIG. 1 is a view for illustrating the luminance characteristics of an LCD device.

FIG. 2 is a view illustrating a display device according to an embodiment.

FIG. 3 is a view illustrating exemplary regions of an LCD module defined according to pixels of the LCD module.

FIG. 4 is a view for explaining a method for controlling luminance of a display device according to an embodiment.

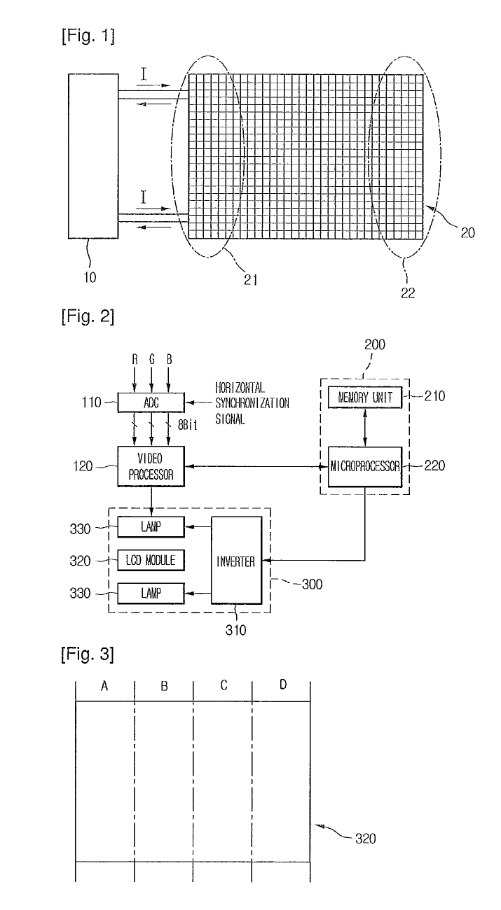

### BEST MODE FOR CARRYING OUT THE INVENTION

Hereinafter, an apparatus and method for controlling luminance of a display device will be more fully described with respect to the accompanying drawings, in which exemplary embodiments are shown.

FIG. 2 is a view illustrating a display device according to an embodiment.

Referring to FIG. 2, the display device includes an analog digital converter (ADC) 110, a video processor 120, a display unit 300, and a control unit 200. The ADC 110 converts R, G, and B analog signals into digital signals using a horizontal synchronization signal. The video processor 120 receives the digital signals from the ADC 110 and converts the digital signals into an image signal having a format suitable for a liquid crystal display (LCD) module 320 of the display unit 300. The display unit 300 displays an image using the image signal processed by the video processor 120. The control unit 200 controls the display unit 300 to operate at predetermined luminance levels according to the image signal processed by the video processor 120.

The display unit 300 includes an inverter 310, lamps 330, and the LCD module 320. The inverter 310 applies a driving current to the lamps 330 (backlight lamps) according to a control signal transmitted from the control unit 200. The lamps 330 emit light according to the driving current received from the inverter 310. The LCD module 320 displays an image corresponding to the image signal transmitted from the video processor 120.

The control unit 200 includes a memory unit 210 and a microprocessor 220. The memory unit 210 stores luminance level conversion values for pixels of the LCD module 320. The microprocessor 220 controls the video processor 120 and the luminance of the LCD module 320 using the inverter ADC 110 according to the luminance level conversion values stored in the memory unit 210.

In an embodiment, the luminance of the LCD module 320 is controlled by varying the luminance levels of pixel regions of the LCD module 320 according the luminance of input image data.

In the memory unit 210, the luminance level conversion values can be stored in a lookup table for the pixels of the LCD module 320. An input luminance level can be different from an output luminance level of the inverter 310 according to the luminance level conversion values.

In detail, when R, G, and B analog signals are input to the ADC 110, the ADC 110 converts the R, G, and B signals into digital signals and outputs the digital signals to the video processor 120.

The video processor 120 converts the digital signal into an image signal and outputs the digital signal to the LCD module 320. Furthermore, the video processor 120 sends information about luminance levels of the image signal to the microprocessor 220.

The microprocessor 220 converts the luminance levels of the image signal into modified luminance levels by calculation or using the lookup table of the memory unit 210.

The microprocessor 220 provides the modified luminance levels to the inverter 310 such that the inverter 310 can apply a current to the lamps 330 according to the modified luminance levels.

FIG. 3 is a view illustrating exemplary regions of the LCD module 320 defined according to the pixels of the LCD module.

The LCD module 320 can be divided into N regions according to the pixels of the LCD module 320. In FIG. 3, the LCD module 320 is divided into regions A, B, C, and D.

For example, when image data having a luminance level of 255 is input to the LCD module 320, the luminance levels of the regions A, B, C, and D of the LCD module 320 can be 255, 251, 248, and 245, respectively.

That is, although the luminance level of the image data is unique (255), the luminance of the LCD module 320 can vary across the A, B, C, and D regions.

Therefore, the control unit 200 modifies the luminance level of the input image data to operate the LCD module 320 at modified luminance levels (luminance compensation).

For example, when the luminance level of input image data is 255, the LCD module 320 can be operated according to modified luminance levels: 245 for the region A, 247 for the region B, 250 for the region C, and 255 for the regions D.

In this case, the regions A, B, C, and D can have the same luminance level of 245. In this way, variations of luminance across the regions A, B, C, and D can be compensated.

In Table 1 below, modified luminance levels of the regions A, B, C, and D for the inverter 310 are shown according to luminance levels of input image data.

TABLE 1

| Luminance | | | | |
|---|---|---|---|---|
| Level | Region A | Region B | Region C | Region D |
| 255 | 245 | 247 | 250 | 255 |
| 250 | 240 | 242 | 245 | 250 |
| 245 | 236 | 238 | 241 | 245 |
| 240 | 231 | 233 | 236 | 240 |
| 235 | 227 | 229 | 232 | 235 |

The luminance level conversion values shown in Table 1 can be stored in a lookup table of the memory unit 210 or can be calculated by the microprocessor 220 in real time.

For example, when the luminance level of image data received from the video processor 120 is 250, the microprocessor 220 can allocate luminance levels of 240, 242, 245, and 250 for the regions A, B, C, and D, respectively, by calculation or using the lookup table of the memory unit 210. As a result, output luminance levels of the regions A, B, C, and D can approach to about 240 when the luminance level of input image data is 250.

The inverter 310 applies a current to the lamps 330 according to the luminance levels output from the microprocessor 220 so that the LCD module 320 can display an image at a uniform luminance level in response to an input image data having a uniform luminance level.

Although the image displayed on the LCD module 320 does not have exactly the same luminance level as that of the input image data, the difference between the luminance levels of the display image and input image data can be kept constant and minimal, and luminance errors (distortions) can be prevented.

In the case where luminance levels are modified using a lookup table such as Table 1, all luminance levels of 0 to 255 can be expressed. Therefore, gray levels can be expressed without a problem.

Meanwhile, when image data having a uniform luminance level is input to the LCD module 320, the luminance level of the LCD module 320 can decrease in a certain direction.

For example, when the LCD module 320 is imaginarily divided into the regions A, B, C, and D as shown in FIG. 3, and image data having a uniform luminance level is input to the LCD module 320, the output luminance level of the LCD module 320 can decrease from the region A to the region D.

For this reason, referring to each row of Table 1, the luminance level conversion values for the regions A, B, C, and D increase from the region A to the region D for a given luminance level of input image data.

In another embodiment, the uniformity of the luminance level of the LCD module 320 can be controlled using measured luminance level of the LCD module 320.

For example, when image data having a uniform luminance level of 255 are input to the LCD module 320, the luminance levels of the regions A, B, C, and D of the LCD module 320 can be 255, 251, 248, and 200, respectively.

That is, although the input image data has a uniform luminance level, the luminance levels of the regions A, B, C, and D of the LCD module 320 are largely different. Particularly, the luminance level of the region D is much lower than that of the region A.

In this case, if the luminance level conversion values of Table 1 is allocated for the regions A, B, C, and D, the output luminance level of the LCD module 320 may vary largely across the regions A, B, C, and D.

Therefore, when image data having a uniform luminance level is input to the LCD module 320, the output luminance levels of the regions A, B, C, and D of the LCD module 320 are measured to calculate a ratio of the maximum luminance level (e.g., of the region A) to the minimum luminance level (e.g., of the region D) and compare the calculated ratio with a critical value. If the calculated ratio is equal to or larger than the critical value, another lookup table such as Table 2 below can be used.

For example, the critical value can be 1.2, and when the calculated ratio is equal to or larger than 1.2, input luminance levels are properly modified.

As explained above by example, when the output luminance levels of the regions A, B, C, and D of the LCD module 320 are 255, 251, 248, and 200, respectively, for input image data having a uniform luminance level of 255, modified luminance levels of 210, 217, 220, and 255 can be allocated for the regions A, B, C, and D, respectively.

In this case, although the regions A, B, C, and D of the LCD module 320 do not have an output luminance level equal to the luminance of the input image data, the difference between the maximum output luminance level and the minimum luminance level is not large, and thus the output luminance level of the LCD module 320 can be uniform. In other words, the output luminance level of the LCD module 320 can be uniform without a region having a relatively much lower luminance level than those of other regions.

In Table 2 below, modified luminance levels of the regions A, B, C, and D for the inverter 310 are shown according to luminance levels of input image data.

TABLE 2

| Luminance | | | | |
|---|---|---|---|---|
| level | Region A | Region B | Region C | Region D |
| 255 | 210 | 217 | 220 | 255 |
| 250 | 205 | 212 | 215 | 250 |
| 245 | 200 | 207 | 210 | 245 |
| 240 | 195 | 202 | 205 | 240 |
| 235 | 190 | 197 | 200 | 235 |

Like the case of the luminance level conversion values of Table 1, the luminance level conversion values illustrated in Table 2 can be stored in a lookup table of the memory unit 210 or can be calculated by the microprocessor 220 in real time.

The inverter 310 applies a current to the lamps 330 according to the luminance levels output from the microprocessor 220 so that the LCD module 320 can display an image at a uniform luminance level in response to an input image data having a uniform luminance level.

Here, if the luminance level of the input image data is 255, the output luminance levels of the regions A, B, C, and D of the LCD module 320 may be in the range from 200 to 210.

Meanwhile, applications of lookup tables such as Tables 1 and 2 can be determined according to the characteristics of the LCD module 320 and the inverter 310. Although two lookup tables (Tables 1 and 2) are explained, more lookup tables can be stored in the memory unit 210 and selectively used according to the situations.

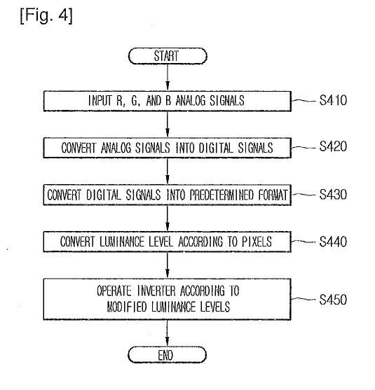

FIG. 4 is a view for explaining a method of controlling luminance of a display device according to an embodiment.

Referring to FIG. 4, R, G, and B analog signals are input to an ADC 110 (S410), and the ADC 110 converts the R, G, and B analog signals into digital signals (S420).

The digital signals are converted into an image signal having a format suitable for an LCD module 320 (S430).

Luminance levels are read from the image signal and are converted into modified luminance levels for pixel regions of the LCD module 320 by using a lookup table stored in the memory unit 210 (S440).

Then, the inverter 310 is driven according to the modified luminance levels (S450).

### INDUSTRIAL APPLICABILITY

The apparatus and method for controlling luminance of a display device can be used in various industrial fields since an image can be displayed on the display device without luminance level distortion caused by the characteristics of the display device.

1. An apparatus for controlling luminance of a display device, the apparatus comprising:
an analog digital converter converting input image data into a digital signal;
a video processor converting the digital signal output from the analog digital converter into a format suitable for a display module;
a control unit receiving the formatted signal from the video processor and converting a luminance level of the formatted signal into modified luminance levels so as to reduce differences between output luminance levels across pixel regions of the display module; and
a display unit displaying the input image data using the formatted signal according to the modified luminance levels.

2. The apparatus according to claim 1, wherein the control unit divides the display module into a plurality regions and converts the luminance level of the formatted signal when an average difference between output luminance levels of the formatted signal across the regions is smaller than a predetermined reference level.

3. The apparatus according to claim 1, wherein the control unit converts the luminance level of the formatted signal into different luminance levels for pixel regions of the display module such that the pixel regions of the display module are allocated different luminance levels for input image data having a uniform luminance level.

4. The apparatus according to claim 1, wherein the modified luminance levels increase or decrease across pixel regions of the display module in a predetermined direction.

5. The apparatus according to claim 1, wherein the display unit comprises: an inverter applying a driving current to a lamp; and
the control unit decreases luminance levels of pixels of the display module as the pixels are located closer to the inverter.

6. The apparatus according to claim 1, wherein the display unit comprises: an inverter applying a driving current to a lamp; and
the control unit divides the display module into a plurality of regions according to a distances from the inverter and decreases luminance levels of the regions as the regions are located closer to the inverter.

7. The apparatus according to claim 6, the control unit calculates an average output luminance level of the regions of the display module for the luminance level of the formatted signal and converts the luminance level of the formatted signal when a difference between a maximum luminance level and a minimum luminance level is smaller than a predetermined reference level.

8. The apparatus according to claim 1, wherein the control unit comprises a memory unit storing a plurality of luminance level conversion values and converts the luminance level of the input image date into luminance levels selected from the luminance level conversion values stored in the memory unit according to a uniformity of output luminance levels of an image displaying on the display unit.

9. A method for controlling luminance of a display device, the method comprising:
converting input image data into a digital signal;
converting the digital signal into a format suitable for a display module;
converting a luminance level of the input image data into modified luminance levels using the formatted signal so as to reduce differences between output luminance levels across pixels of the display module; and
displaying the input image data using the formatted signal according to the modified luminance levels.

10. The method according to claim 9, wherein the converting of the luminance level of the input image data comprises:
dividing the display module into a plurality regions; and
converting the luminance level of the input image data when an average difference between output luminance levels of the formatted signal across the regions is smaller than a predetermined reference level.

11. The method according to claim 9, wherein the converting of the luminance level of the input image data comprises converting the luminance level of the input image data into different luminance levels for pixel regions of the display module such that the pixel regions of the display module are allocated different luminance levels for the input image data having a uniform luminance level.

12. The method according to claim 9, wherein the converting of the luminance level of the input image data comprises decreasing or increasing the modified luminance levels across pixels of the display module in a predetermined direction.

13. The method according to claim 9, wherein the displaying of the input image data comprises:
applying a driving current to an inverter according to the modified luminance levels;
operating a lamp at a luminance level corresponding to the modified luminance levels; and
displaying the input image data on the display module using the formatted signal according to the modified luminance levels.

14. The method according to claim 13, wherein the converting of the luminance level of the input image data comprises:
dividing the display module into a plurality of regions according to a distances from the inverter; and
allocating the modified luminance levels to the regions such that a region closer to the inverter is allocated a smaller modified luminance level.

15. The method according to claim 13, wherein the converting of the luminance level of the input image data comprises decreasing luminance levels allocated for pixels of the display module as the pixels are located closer to the inverter.

16. The method according to claim 9, wherein the converting of the luminance level of the input image data comprises converting the luminance level of the input image date into modified luminance levels using selected from luminance level conversion values stored in a memory unit for uniformity of output luminance levels of an image displaying on the display unit.

17. A method for controlling luminance of a display device, the method comprising:
converting analog image data into a digital signal;
converting the digital signal into a format suitable for a display module;
detecting a difference between a maximum luminance level and a minimum luminance level of the formatted signal;
if the difference is smaller than a predetermined reference value, reading luminance level conversion values from a lookup table stored in a memory unit;
converting a luminance level of the formatted signal into the luminance level conversion values; and
displaying the image data on the display module according to the luminance level conversion values.

18. The method according to claim 17, wherein the luminance level conversion values gradually increase or decrease according to pixels of the display module.

19. The method according to claim 18, wherein a smaller luminance level conversion value is allocated for a pixel closer to an inverter applying a driving current to a lamp.
